(19) United States
(12) Patent Application Publication
(10) Pub. No.: US 2004/0131847 A1
(43) Pub. Date: Jul. 8, 2004

(54) Film and hot-stamping method

(76) Inventor: Alain Bethune, Savigny (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/470,277

(22) PCT Filed: Feb. 6, 2002
(86) PCT No.: PCT/FR02/00468

(30) Foreign Application Priority Data
Feb. 7, 2001 (FR) 01/01641

(51) Int. Cl. B32B 7/12

(52) U.S. Cl. 428/347; 428/344; 428/447

(57) ABSTRACT

The present invention relates to a film (10) for the decoration of a surface (100) by hot marking, in particular a surface made of glass or metal, the film comprising a first layer (11) of a heat-sensitive adhesive intended to be brought in contact with the said surface, a second layer (12) of a material suitable for forming the said decoration, a protective support (13) fixed on the second layer via a layer (14) of a heat-sensitive material, characterised in that the film comprises at least one first compound (20) capable of chemically reacting in a humid environment with at least one second compound of the said surface (10) so as to promote the adhesion of the film when it is applied to the said surface.

The present invention relates to a film and to a method for the decoration of a surface by hot marking, in particular a surface made of glass, crystal, ceramic, metal or metal alloys.

Surfaces made of glass, crystal, metal or metal alloy are traditionally decorated by ink printing, enamelling, chemical attack or with paint. Such methods of decoration have several drawbacks. Specifically, they entail evaporations of solvent and CO₂, especially when the inks are being fired. Furthermore, they do not allow certain type of decoration to be obtained, for example metallic effects of any colour such as can be obtained by hot-marking methods. However, it is difficult to use a hot-marking method on smooth inorganic surfaces such as glass, crystal, or metal, because the adhesive compositions provided on hot-marking films adhere poorly to such surfaces.

U.S. Pat. No. 6,136,382 describes a method for decorating a vitreous article which improves the adhesion of a decoration, obtained in particular by hot marking. The method consists of applying a silane-based composition to the article by spraying, then in applying an ink which is dried by suitable radiation. A traditional hot-marking film is then applied to the regions where the ink was deposited, at a temperature which allows an adhesive layer of the hot-marking film to adhere to the regions decorated with the ink. The film is not applied directly to the glass surface, but instead an intermediate layer is necessary. Furthermore, in this type of method the decoration has to be applied relatively quickly after the glass had been treated, because the glass is not stable in the long term, and the silane-based composition will have a tendency to lose its effectiveness in terms of its adhesion-promoting function in the course of time. This is because when the glass is being melted, there is a release of sodium hydroxide because, since the sodium-oxygen bond is very weak, there is liberation of sodium ions which make the environment alkaline. The alkaline OH⁻ ions chemically attack the silica and make the surface of the glass unstable.

Patent Applications EP 0 668 170 and EP 0 825 218 also describe methods for decorating an article made of glass or ceramic, in which a silane-based composition is sprayed onto the glass or ceramic article before applying a hot-marking film. Here again, the decoration has to be applied relatively quickly after the glass had been treated because the silane-based composition will have a tendency to lose its effectiveness in terms of its adhesion-promoting function in the course of time.

U.S. Pat. No. 3,907,974 describes hot-transferable transfers forming labels that can be transferred onto glass or ceramic surfaces. The labels are formed by a plurality of layers, in particular a varnish layer, a printed design layer and an adhesive layer. In order to improve the stability of the label, its resistance to chemical products, its resistance to abrasion and friction, at least one of the layers contains polymerisable crosslinking agents which are capable of crosslinking the resins found in the adjacent layers in order to form solid cohesive chemical bonds between layers and within a given layer. Before applying the label to a surface, for example made of glass, it is necessary to treat this surface with an adhesion-promoting agent such as silane. Hence, there are the same drawbacks as those which have just been discussed above in connection with the prior spraying of silane onto the surface to be decorated.

It is therefore one of the objects of the invention to provide a film and a method for the decoration of a surface by hot marking, making it possible to improve the adhesion of the film to a surface which is, in particular, unreceptive to an adhesive composition, which do not have the drawbacks of the prior art.

It is, in particular, an object of the invention to provide a hot-marking method which is independent of the way in which the surface to be decorated is manufactured, and which does not require prior treatment of the surface or coating with an intermediate layer.

According to the invention, these objects are achieved by producing a film for the decoration of a surface by hot marking, in particular a surface made of glass or metal, the film comprising a first layer of a heat-sensitive adhesive intended to be brought in contact with the said surface, a second layer of a material suitable for forming the said decoration, a protective support fixed on the second layer via a layer of a heat-sensitive material, characterised in that the film comprises at least one first compound capable of chemically reacting in a humid environment with at least one second compound of the said surface so as to promote the adhesion of the film when it is applied to the said surface.

Hence, since the compound promoting the adhesion of the film to the surface lies inside the hot-marking film whose structure is stable, in particular compared with that of a vitreous support, its effectiveness will be maintained in the course of time. Furthermore, it is unnecessary for the surface intended to receive the decoration to be treated in order to promote the adhesion, and the film can be applied directly to the surface to be decorated.

Moreover, the chemical reaction which takes place between the first compound present in the film and the second compound of the surface makes it possible to create a chemical bond which is relatively stable.

Preferably, the first compound is a silane or a silane derivative of the chemical formula:

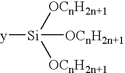

in which y is an organofunctional group capable of grafting onto an organic polymer of the hot-marking film, for example onto the adhesive. This involves, for example, a carbon double bond; and in which, preferably, 0≦n≦2.

Such a compound makes it possible to create a covalent bond between the surface to be decorated and the hot-marking film. Such a bond provides maximum bonding energy.

According to one embodiment, the first compound is arranged inside the first layer, namely in the adhesive layer, that is to say in the layer which comes directly in contact with the surface to be decorated. Hence, an optimum first compound number will be able to react with a second compound of the surface to be decorated. The first layer comprises from 0.5% to 5% by weight of the first compound, and preferably from 1% to 3%.

According to another embodiment, first compound is arranged inside a layer adjacent to the first layer.

The first layer of the film, that is to say the adhesive layer which makes it possible to fix the decoration onto the surface to be decorated, consists for example of a chloro rubber or a rubber of acrylic origin. This layer is hot-meltable, and therefore allows the decoration to be made to adhere to the surface under the effect of heat.

The second layer making it possible to form the decoration is formed at least in part by a metallic material, for example aluminium. The second layer may also be formed at least in part by an organic material, such as an ink, a pigment, etc. This second layer is advantageously covered with a varnish on the opposite side from the first layer. This varnish may be coloured or uncoloured. It makes it possible to obtain a coloured or uncoloured metallic effect, as well as to protect the metallic or organic second layer.

The heat-sensitive material making it possible to fix the support onto the second layer or onto the varnish layer is advantageously a wax, a polymer with very low molecular weight based on ethylene, for example, or a silicone. When the film is being applied to the surface, it makes it possible to detach the support from the rest of the film by melting under the effect of heat.

The protective support of the film consists of a thermoplastic film, in particular polyester. It makes it possible to protect the decoration, in particular when pressure and heat are applied during the transfer.

The objects of the invention are also achieved by producing an article, in particular for packaging, decorated by means of a film such as that described above. The surface of the article on which the film is attached is made of glass, crystal, metal or ceramic. It is, for example, a glass bottle or alternatively an object, for example a container, covered with a metallic coating.

According to another aspect of the invention, the objects of the invention are achieved by providing a method for the decoration of a surface by hot marking, in particular a surface made of glass or metal, in which a film such as that described above is brought in contact with the said surface and pressure and heat are applied in a humid environment to at least one region of the film corresponding to the decoration.

The heat should be such that it allows the thermosensitive adhesive of the first layer to be made to melt in order to be mechanically fixed to the surface to be decorated with the aid of the pressure applied to the film. Furthermore, a pressure is applied to the film at a temperature ranging from 120 to 300° C. Such a temperature is sufficient to make the adhesive melt relatively quickly while not being too high so as not to damage the film. Furthermore, the exerted pressure makes it possible to detach the support from the layer forming the decoration.

The humid environment makes a possible to obtain, for example starting from silane, silanols which by condensing will make it possible to create a covalent bond between the film and the surface, according to a reaction which will be described below.

Advantageously, the hot-marking method is carried out in a humid environment with a hygrometry level greater than or equal to 50 RH. This humidity makes it possible to hydrolyse a sufficient number of first compounds in order, for example in the case of silane, to obtain a sufficient number of silanols capable of creating a covalent bond between the film and the surface.

The method is advantageously carried out in an acidic environment so as to catalyse the reaction which makes it possible to create the covalent bonds between the film and the surface. For example, a small quantity of acid may be introduced into the composition intended to form the adhesive layer. Alternatively, an acidic composition is applied to the surface to be decorated, before the hot-marking film is applied.

Apart from the provisions explained above, the invention consists of a certain number of other provisions which will be explained below, by way of non-limiting exemplary embodiments that are described with reference to the appended figures, in which:

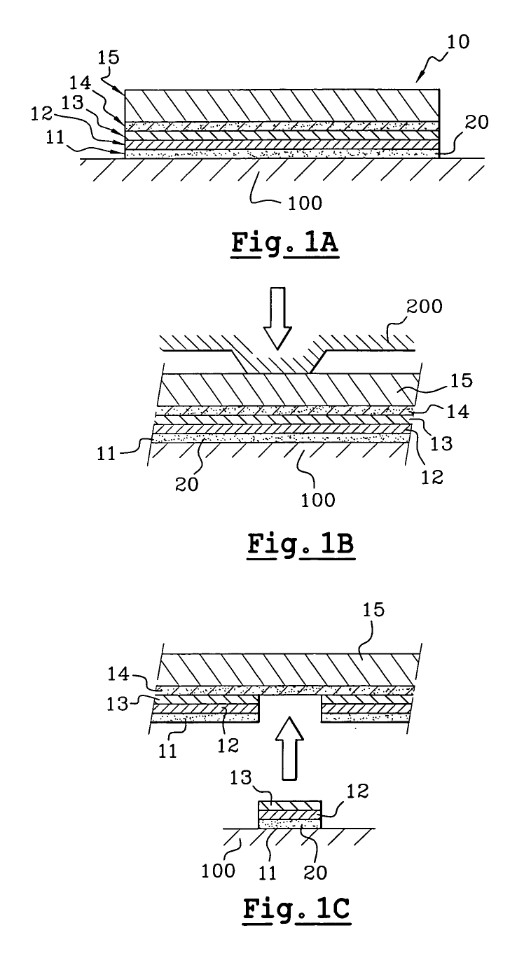

FIGS. 1A to 1C schematically describe the various steps of the hot-marking method using the hot-marking film according to one embodiment of the invention.

The hot-marking film 10 represented, in particular, in FIG. 1A is a structure which comprises a plurality of layers.

A first layer 11 of adhesive is formed from a hot-meltable adhesive. It is, for example, a chloro rubber. A first face of this first layer is intended to be applied to the surface 100 to be decorated. This second face of the adhesive layer 11 is covered with a second layer 12, formed by an aluminium foil intended to form the decoration. The aluminium foil 12 is advantageously covered with a layer of varnish 13 which may be coloured, for example a resin. The varnish layer 13 is covered with a layer of wax 14 which is covered by a support 15, for example is made of polyester.

A silane 20, for example a silane marketed by the company Witco Corporation under the reference A1100, is included in the adhesive layer 11.

Advantageously, a small quantity of acid, for example hydrochloric acid, is introduced into the adhesive layer so as to obtain a pH ranging from 4 to 7, and preferably about 5. The quantity of acid in the layer adhesive ranges, for example, from 0.1 to 10% by weight, preferably from 0.5 to 5%.

The decoration which will be applied to the surface to be decorated is not very thick, which is why the various layers of the film that are intended to remain on the surface to be decorated are very thin. Conversely, the polyester support 15 is relatively thick compared with the other layer, on the one hand so as to consolidate the entire film before transfer and, on the other hand, to protect the decoration during transfer. The support 15 has, for example, a thickness of the order of 12 μm. The wax layer 14 may have a thickness of the order 0.01 μm, the varnish layer 13 a thickness of the order of 1 μm, the aluminium layer 12 a thickness of the order of 0.02 μm and the adhesive layer 11 has, for example, a thickness ranging from 0.8 to 3.50 μm.

In order to produce such a film, use is made of a coating technique including continuous vacuum metallization for metallic effects and a printing method, for example photogravure, for inks or colouring varnishes. An equivalent printing method may be used in order to deposit the mixture of adhesive and silane as a surface layer.

The hot-marking film which has just been described is, in particular, used for decorating a glass object, for example a bottle.

In order to decorate the bottle, the film is brought in contact with the external surface of the bottle, as illustrated in FIG. 1A, and a pressure is applied to the film by means of a hot gilding iron 200, having reliefs corresponding to the decoration to be produced, which is brought onto the external surface of the support of the film (FIG. 1B).

The iron 200, heated for example to 280° C., makes the chloro rubber melt in the regions corresponding to the decoration, which becomes mechanically fixed onto the bottle owing to the pressure applied by the iron. The chloro rubber is hence secured to the bottle in the regions where the iron is applied. The aluminium foil covered with the varnish is also secured to the bottle in these regions, since it remains integrated with the rubber. Under the effect of heat and pressure, the wax provided between the varnish and the support facilitates detachment of the polyester support from the rest of the film (FIG. 1C). The wax tends to remain on the support to which has been applied.

Furthermore, the film is brought in contact with the bottle in a humid environment with a hygrometry level of the order of 50% or more. The humid environment makes it possible to obtain silanols from silane according to the reaction:

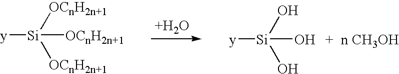

It is clear that when n is equal to 0, this reaction does not take place given that a silanol is already present.

The silanol will then condense and react with the active groups at the surface of the glass, for example the vitrifying SiOH₄, so as to form a covalent bond with the glass of the bottle according to the reaction:

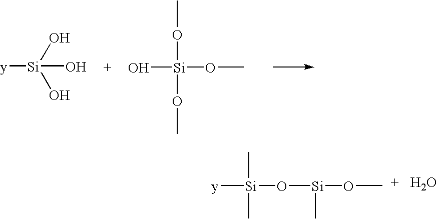

The bonds obtained in this way promote adhesion of the film to the glass surface.

The film and the method which have just been described can also be used for transferring a decoration onto an object covered with a metallic coating, for example an aluminium coating. In this case, there is a reaction with the AlOH₃ group so as to form a covalent bond according to the reaction:

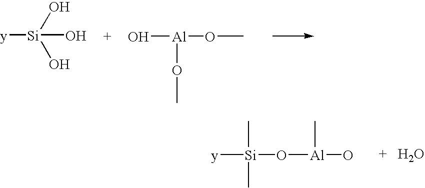

According to another embodiment, the film's second layer 12 suitable for forming the decoration is formed in part, on the one hand, by a metallic film and, on the other hand, by an organic material, for example an ink. It is hence possible, is for example, to decorate a bottle with a first pattern formed by an ink, for example letters, and a second pattern having a metallic effect.

In order to produce such a film, the polyester support 15 is covered with a wax layer 14 on which a layer of varnish 13 is deposited, for example a polyurethane, which may be coloured or uncoloured, for example by photogravure. An organic ink is then deposited on the varnish layer 13 by a printing technique, for example photogravure. The negative corresponding to the first pattern formed by the ink which is intended to be obtained is in this way printed directly. A layer of organic varnish, to which the metallic material cannot adhere, is then deposited on the rest of the varnish layer, expect in a region corresponding to the negative of the second pattern. The ink-printed region may itself be covered with the organic varnish or alternatively, in particular in the event that the ink does not itself allow adhesion of the metallic material, covering it with this varnish may be obviated. The entire film is then coated with a metallic material by continuous vacuum metallization, the metallic material adhering only in the region which has not been coated with varnish and which corresponds to the negative of the second pattern. Lastly, everything is covered with a mixture 11 of adhesive and silane, for example by photogravure.

Alternatively, in order to produce such a film, the polyester support 15 is covered with a wax layer 14 on which a layer of varnish 13 is deposited which may be coloured or uncoloured, for example by photogravure. The ink is deposited on the varnish layer 13 by a printing technique, for example photogravure, the negative corresponding to the first pattern of the decoration which is intended to be obtained being drawn directly on this varnish layer. A metallic deposit is then produced under partial vacuum on a portion of the film which has not been ink-printed. This deposit is produced by cathodic sputtering is order to deposit the metal with precision in the intended region corresponding to the second pattern of the decoration. Alternatively, the metal may be partially deposited before the ink-printing is carried out. Lastly, everything is covered with a mixture of adhesive and silane 11.

In order to decorate a bottle, the film is brought in contact with the external surface of the bottle, and pressure is applied in the regions of the film which have the two patterns of the decoration, by means of a hot gilding iron which is brought onto the external face of the film. The iron used this time is a solid iron which does not have any particular reliefs, given that the decoration has already been formed on the film.

In the detailed description above, reference has been made to preferred embodiments of the invention. It is clear that modifications may be made to them without departing from the spirit of the invention as claimed below.

1. Film (10) for the decoration of a surface (100) by hot marking, in particular a surface made of glass or metal, the film comprising a first layer (11) of a heat-sensitive adhesive intended to be brought in contact with the said surface, a second layer (12) of a material suitable for forming the said decoration, a protective support (15) fixed on the second layer via a layer (14) of a heat-sensitive material, characterised in that the film comprises at least one first compound (20) capable of chemically reacting in a humid environment with at least one second compound of the said surface (10) so as to promote the adhesion of the film when it is applied to the said surface.

2. Film according to claim 1, characterised in that the first compound (20) is a silane or silane derivative.

3. Film according to claim 1 or 2, characterised in that the first compound (20) is arranged inside the first layer (11).

4. Film according to claim 3, characterised in that the first layer (11) comprises from 0.5% to 5% by weight of the said first compound (20), and preferably from 1% to 3%.

5. Film according to claim 1 or 2, characterised in that the first compound (20) is arranged inside a layer adjacent to the first layer (11).

6. Film according to claim 1 or 2, characterised in that the first layer (11) consists of a chloro rubber or a rubber of acrylic origin.

7. Film according to any one of the preceding claims, characterised in that the second layer (12) is formed at least in part by a metallic material, in particular aluminium.

8. Film according to any one of claims 1 to 7, characterised in that the second layer (12) is formed at least in part by an organic material, in particular a pigment or ink.

9. Film according to any one of the preceding claims, characterised in that the second layer (12) is covered with a varnish (13) on the opposite side from the first layer (11).

10. Film according to any one of the preceding claims, characterised in that the heat-sensitive material is a wax.

11. Film according to any one of the preceding claims, characterised in that the protective support (15) consists of a thermoplastic film, in particular of polyester.

12. Article, in particular for packaging, decorated by means of a film (10) according to any one of the preceding claims.

13. Article according to claim 12, characterised in that the surface (100) of the article on which the film (10) is attached is made of glass, crystal, metal or ceramic.

14. Method for the decoration of a surface (100) by hot marking, in particular a surface made of glass or metal, in which a film (10) according to any one of claims 1 to 11 is brought in contact with the said surface (100) and pressure and heat are applied in a humid environment to at least one region of the film corresponding to the decoration.

15. Method according to claim 14, characterised in that it is carried out in a humid environment with a hygrometry level greater than or equal to 50 RH.

16. Method according to either one of claims 14 and 15, characterised in that it is carried out at a temperature ranging from 120 to 300° C.

17. Method according to any one of claims 14 to 16, characterised in that it is carried out in an acidic environment.
